(19) United States
(12) Patent Application Publication
(10) Pub. No.: US 2018/0292883 A1
(43) Pub. Date: Oct. 11, 2018

(54) Methods and Devices to Improve Performances and Efficiencies of Electrical and Electronic Systems

(71) Applicant: Iman Rezanezhad Gatabi, Grand Forks, ND (US)

(72) Inventor: Iman Rezanezhad Gatabi, Grand Forks, ND (US)

(21) Appl. No.: 15/859,262

(22) Filed: Dec. 29, 2017

Related U.S. Application Data
(60) Provisional application No. 62/483,440, filed on Apr. 9, 2017.

(51) Int. Cl. G06F 1/32; G06F 9/4401

(52) U.S. Cl. CPC G06F 1/3265; G06F 9/4418; G06F 1/3296

(57) ABSTRACT

This application discloses methods to be implemented in electronic devices having a display, wherein a presence of an object or a human, or a movement of an object or a human provides a signal to turn ON the said display or device, or to bring the said display or device out of a hibernate, or a power saving, or a lock mode. This application also discloses methods to be implemented in electronic devices having a display, wherein an absence an object or a human, or an absence of a moving object or a moving human provides a signal to turn OFF the said display or device, or to bring the said display or device into a hibernate, or a power saving or a lock mode.

### CROSS-REFERENCE TO RELATED APPLICATIONS

This application claims the benefits of U.S. provisional application Ser. No. 62/483,440, filed on Apr. 9, 2017.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Security and energy efficiency of electrical and electronic systems are exceedingly important in today's fast-growing industry. Different methods are currently implemented to automatically bring electronic devices out of a hibernate or a power saving mode, or vice versa, to put the electronic devices into a hibernate, or a power saving, or a lock mode. Improving these methods and implementing new techniques for this purpose are critical for achieving high performance and energy efficient electrical or electronic devices.

Related arts in the field of the present invention include (but are not limited to) personal computers having a display, wherein the said display and/or personal computer goes into a hibernate mode if a user does not use the keyboard or mouse of the said personal computer for a specific amount of time. After the said display and/or personal computer went into the said hibernate mode, the user may decide to use the said personal computer again. The user may do so by pressing a key on the keyboard or by moving the mouse of the said personal computer. Alternatively, in other prior arts, the said personal computer may be set in a way such that it goes into a lock mode instead of going into a hibernate mode if the user does not use the keyboard or mouse of the said personal computer for a specific amount of time.

In other prior arts, in order to bring a smartphone and/or its display out of a hibernate mode, one should press the home button or the turn ON/OFF button of the said smartphone. This may be difficult specially in dark environment where it is not easy to find the said smartphone and press its home or ON/OFF button.

### BRIEF SUMMARY OF THE INVENTION

This application discloses methods to be implemented in devices having a display, wherein the said methods may be used to turn ON the said display or device, or to bring the said display or device out of a hibernate, or a power saving, or a lock mode. Moreover, this application also discloses methods to turn OFF the said display or device, or to bring the said display or device into a hibernate, or a power saving or a lock mode.

### BRIEF DESCRIPTION OF THE SEVERAL VIEWS OF THE DRAWING

FIG. 1 illustrates a prior art, where it depicts a laptop having a display and a keyboard.

FIG. 2 shows a prior art, where it illustrates a smartphone having a display, a home button and an ON/OFF button.

FIG. 3 shows an example embodiment of the invention where it depicts a laptop comprising of a display and a sensor.

FIG. 4 shows an example embodiment of the invention where it depicts a smartphone comprising of a display and a sensor.

### DETAILED DESCRIPTION OF THE INVENTION

Different examples will be described in details that represent some example embodiments of the present invention. Although the technical and structural descriptions presented herein are representative for the purposes of describing the present invention, the described invention may be embodied in many alternate forms and should not be limited to the example embodiments described herein.

The described examples can be modified in various alternative forms. For example, the thickness and dimensions of the regions in drawings may be exaggerated for clarity. Unless otherwise stated, there is no intention to limit the invention to the particular forms disclosed herein. However, examples are used to describe the present invention and to cover some modifications and alternatives within the scopes of the invention.

The spatially relative terms which may be used in this document such as “underneath”, “below” and “above” are for the ease of description and to show the relationship between an element and another one in the figures. If the device in the figure is turned over, elements described as “underneath” or “below” other elements would then be “above” other elements. Therefore, for example, the term “underneath” can represent an orientation which is below as well as above. If the device is rotated, the spatially relative terms used herein should be interpreted accordingly.

Unless otherwise stated, variations of the shapes of the figures as a result of, for example, manufacturing techniques and tolerances are expected. Therefore, the regions illustrated in figures are schematic and their shapes do not necessarily show the actual shape of the fabricated device. Unless otherwise stated, there is no intention to limit the invention to the values (such as dimensions and voltages) that may be used to describe the example embodiments. These values are selected to describe the related characteristics for a better understanding of the presented methods or devices. Unless otherwise stated, the terms used herein have the same meanings as commonly understood by someone with ordinary skills in the invention field.

Throughout this document, the whole device structure or the entire systems in provided example embodiments may not be presented for the sake of simplicity. This can be understood by someone with ordinary expertise in the field of invention. For example, when showing a TV set, we may just show the screen and turn ON/OFF button and not the volume buttons. In such cases, any new or well-known designs for the un-shown parts are expected. Therefore, it should be understood that the provided example embodiments may just have illustrations that are mainly intended to show the scope of the invention and different designs of other parts of the presented example embodiments are expected.

Throughout this document, it is referred to “moving” objects or humans, or a “movement” of an object or a human, in an area near an electronic device. It needs to be mentioned that an object or a human is “moving” or has “movement” in an area near a device if the spacing between any point of that object or human to a point of the said device changes over time. Therefore, for example, if an object and an electronic device are placed in a car, wherein the said car is travelling at a speed of 10 miles per hour with respect to ground, both the object and the electronic device are “moving” with respect to the ground, but is possible that the object and the electronic device are not “moving” with respect to each other.

This application discloses methods to be implemented in devices having a display, wherein the said methods may be used to turn ON the said display, or to bring the said display out of a hibernate, or a power saving, or a lock mode. Moreover, this application also discloses methods to turn OFF the said display, or to bring the said display into a hibernate, or a power saving or a lock mode.

An example embodiment of this invention is an electronic device comprising of a display, said electronic device has a sensor, wherein a presence of an object or a human, or a movement of an object or human, within a certain area near the said sensor provides a signal to turn ON the said display, or to bring the said display out of a hibernate, or a power saving, or a lock mode. In one example embodiment, the said device is a smartphone. In another example embodiment, the said device is a tablet. In other example embodiments, the said device may be a monitor, or a television, or a Liquid Crystal Display (LCD), or a laptop. In some example embodiments, the said sensor is a Passive Infrared (PIR) sensor, or a Charge Coupled Device (CCD) of a camera, or an ultrasonic sensor. In other example embodiments, the said signal is used to turn ON the said device or another device, or to bring the said device or another device out of a hibernate, or a power saving, or a lock mode. In example embodiments that the said device is a smartphone, by implementation of the present invention, a user may be able to bring the display of the said smartphone out of a hibernate mode by moving his hand within a specific area of the said smartphone. This may help to find the said smartphone easier in dark environments.

Another example embodiment of the present invention is an electronic device comprising of a display, said electronic device has a sensor, wherein an absence of an object or a human, or an absence of a moving object or a moving human, within a certain area near the said sensor provides a signal to turn OFF the said display, or to bring the said display into a hibernate, or a power saving or a lock mode. In some example embodiments, the said objects or humans need to be absent for a certain amount of time in order for the said display to turn OFF or to go into a hibernate, or a power saving, or a lock mode. In some example embodiments, the said signal is used to turn OFF the said device or another device, or to bring the said device or another device into a hibernate, or a power saving, or a lock mode. In one example embodiment, the said device is a smartphone. In another example embodiment, the said device is a tablet. In other example embodiments, the said device may be a monitor, or a television, or a Liquid Crystal Display (LCD), or a laptop. In some example embodiments, the said sensor is a Passive Infrared (PIR) sensor, or a Charge Coupled Device (CCD) of a camera, or an ultrasonic sensor.

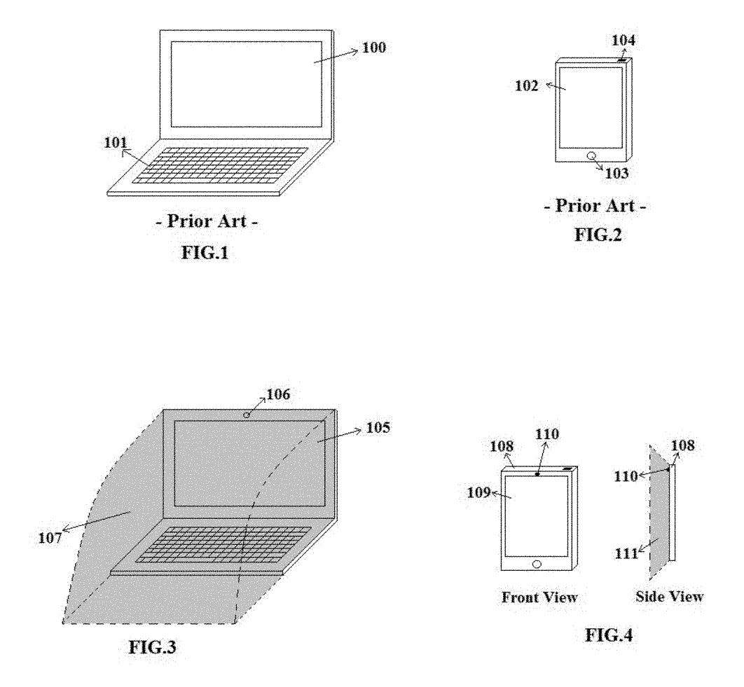

FIG. 1 illustrates a prior art, where it depicts a laptop having a display 100 and a keyboard 101. When the said laptop is not used for a certain amount of time, the said laptop and its display 100 automatically go into a hibernate or a power saving mode. When users wants to use the said laptop, they can bring the said laptop out of the said hibernate or power saving mode by pressing a key of the keyboard 101. Still referring to FIG. 1, when a video is played on the said laptop, if none of the keys of the said keyboard 101 is pressed for a certain amount of time, the said laptop or its display 100 goes into a hibernate or a lock mode.

FIG. 2 shows another prior art, where it illustrates a smartphone having a display 102, said smartphone has a home button 103 and an ON/OFF button 104. When the said smartphone is not used for a certain amount of time, the said smartphone and its display 102 automatically go into a hibernate or a power saving mode. When users wants to use the said smartphone, they can bring the said smartphone out of the said hibernate or power saving mode by pressing the said home button 103 or the said ON/OFF button 104.

FIG. 3 shows an example embodiment of the invention where it depicts a laptop comprising of a display 105, said laptop has a sensor 106, wherein an absence of an object or a human, or an absence of a moving object or a moving human, within a certain area (volume 107 depicted in gray color) near the said sensor provides a signal to turn OFF the said display 105, or to bring the said display 105 into a hibernate, or a power saving mode. Still referring to FIG. 3, a presence of an object or a human, or a movement of an object or a human, within area 107 near the said sensor, provides a signal to turn ON the said display, or to bring the said display out of a hibernate, or a power saving mode. In some example embodiments, a user may adjust the dimensions of volume 107 through a program or app in the said laptop.

The present invention may be implemented in a laptop in a way such that the said laptop comes out of a hibernate mode if a person seats within a specific area near the said laptop. The present invention may also be implemented in a laptop in a way such that the said laptop goes into a hibernate mode when no person seats within a specific area near the said laptop. In some example embodiments, said laptop can be set in a way such that it comes out of a hibernate, power saving, or a lock mode if a human or an object moves within a certain area near the said laptop. In some example embodiment, a PIR sensor may be implemented in the said laptop to sense a movement of a human or an object within a specific area near the said laptop.

FIG. 4 shows an example embodiment of the invention where it depicts a smartphone 108 comprising of a display 109, said smartphone has a sensor 110, wherein an absence of an object or a human for a certain amount of time, or an absence of a moving object or a moving human for a certain amount of time, within a certain area (volume 111 depicted in gray color) near the said sensor 110 provides a signal to turn OFF the said display 109, or to bring the said display 109 into a hibernate, or a power saving or a lock mode. Still referring to FIG. 4, a presence of an object or a human, or a movement of an object or a human, within area 111 near the said sensor provides a signal to turn ON the said display, or to bring the said display and/or smartphone out of a hibernate, or a power saving, or a lock mode. A user may bring the smartphone 108 and/or its display 109 out of a hibernate mode by waving his hand within the area 111. In some example embodiments, the sensor 110 is an infrared sensor. In other example embodiments, the sensor 110 is a camera. In some example embodiments, a user may adjust the dimensions of volume 111 through a program or app in the smartphone 108.

1. An electronic device comprising of a display, said electronic device has a sensor, wherein a presence of an object or a human, or a movement of an object or human, within a certain area near the said sensor provides a signal to turn ON the said display, or to bring the said display out of a hibernate, or a power saving, or a lock mode.

2. The electronic device of claim 1, wherein the said device is a smartphone.

3. The electronic device of claim 1, wherein the said device is a tablet.

4. The electronic device of claim 1, wherein the said device is a monitor.

5. The electronic device of claim 1, wherein the said device is a television.

6. The electronic device of claim 1, wherein the said display is a Liquid Crystal Display.

7. The electronic device of claim 1, wherein the said sensor is a Passive Infrared (“PIR”) sensor.

8. The electronic device of claim 1, wherein the said device is a laptop.

9. The electronic device of claim 1, wherein the said sensor is a camera.

10. The electronic device of claim 1, wherein the said sensor is an infrared sensor.

11. The device of claim 1, wherein the said signal is used to turn ON the said device or another device, or to bring the said device or another device out of a hibernate, or a power saving, or a lock mode.

12. An electronic device comprising of a display, said electronic device has a sensor, wherein an absence of an object or a human, or an absence of a moving object or a moving human, within a certain area near the said sensor provides a signal to turn OFF the said display, or to bring the said display into a hibernate, or a power saving or a lock mode.

13. The electronic device of claim 12, wherein the absence of the said objects or humans for a certain amount of time provides a signal to turn OFF the said display or to bring the said display into a hibernate, or a power saving, or a lock mode.

14. The electronic device of claim 12, wherein the said device is a smartphone.

15. The electronic device of claim 12, wherein the said device is a tablet.

16. The electronic device of claim 12, wherein the said device is a monitor.

17. The electronic device of claim 12, wherein the said display is a Liquid Crystal Display.

18. The electronic device of claim 12, wherein the said sensor is a Passive Infrared (“PIR”) sensor.

19. The electronic device of claim 12, wherein the said device is a laptop.

20. The electronic device of claim 12, wherein the said sensor is a camera.

21. The electronic device of claim 12, wherein the said sensor is an infrared sensor.

22. The electronic device of claim 12, wherein the said device is a television.

23. The device of claim 12, wherein the said signal is used to turn OFF the said device or another device, or to bring the said device or another device into a hibernate, or a power saving, or a lock mode.
